(19) United States
(12) Patent Application Publication
(10) Pub. No.: US 2009/0066096 A1
(43) Pub. Date: Mar. 12, 2009

(54) Vehicle grille including structural inner and decorative outer snap-in features with, and/or method of making the same

(76) Inventors: William J. Doroghazi, Livonia, MI (US); Greg Hintzke, Macomb Twp., MI (US); Thomas J. Fenbert, Maybee, MI (US)

Correspondence Address: NIXON & VANDERHYE, PC, 901 NORTH GLEBE ROAD, 11TH FLOOR, ARLINGTON, VA, 22203, US

(21) Appl. No.: 11/896,939

(22) Filed: Sep. 6, 2007

(51) Int. Cl. B60R 19/52

(52) U.S. Cl. 293/115

(57) ABSTRACT

In certain example embodiments of this invention, there is provided a grille for a vehicle. The grille comprises a structural inner member and a decorative outer member, which includes a plurality of molded-in snap features to engage with the structural inner member at a plurality of corresponding snap-receiving points or locations of the structural inner member. A plurality of snap features are molded into the structural inner member and/or the decorative outer member to engage with the vehicle at a plurality of corresponding attachment points or locations on the vehicle. The plurality of snap features molded into the structural inner member and/or decorative outer member are arranged to provide a secure connection between the grille and the vehicle free from secondary fasteners therebetween.

### FIELD OF THE INVENTION

Certain example embodiments of this invention relate to a grille for a vehicle (e.g., car, SUV, truck or the like) and, more particularly, to a vehicle grille including a decorative outer and a structural inner that includes a plurality of snap-in features that reduces or eliminates the need for secondary fasteners when connecting the grille components to each other and/or when connecting the grille to the vehicle.

### BACKGROUND AND SUMMARY OF EXAMPLE EMBODIMENTS OF THE INVENTION

Systems for connecting front grilles to vehicles are known in the art. Indeed, there are many variations of decorative grille assemblies in the automotive marketplace. Conventionally, metal clips have been used to attach a front grille to a vehicle's grille opening reinforcement (GOR) structure in front of the vehicle's radiator. Currently, grille assemblies use mechanical fasteners (e.g., screws, metal clips, etc.) and sometimes also incorporate molded-in snap features to attach to the vehicle via the fascia, hood, or front-end module. As the vehicle is driven, air flowing through the grille reaches the radiator to help cool water and/or anti-freeze fluid therein in a known manner.

Unfortunately, such conventional techniques suffer from several drawbacks and further improvements could still be made. Metal clips often must be put on at the assembly line facility, which requires an extra person(s) at the assembly line facility and/or additional cost. Accordingly, grilles attached to vehicles in such a manner are prone to falling off of the vehicle and/or rattling during rough operating conditions (e.g., off-road driving, and/or after years of conventional driving). Where other attachment features including screws and the like are used to better secure the grilles to the vehicles, additional time and component costs are introduced, as more persons are required to do more manual, mechanical processes during assembly.

Typically, grilles offer little or no structural advantage to the front end of the vehicle and are merely decorative components through which air flows to the radiator. Thus, any additional structural components must be separately provided and attached to the vehicle. This requires additional hardware components as well as time requirements relating to installation.

Thus, it will be appreciated that there is a need in the art for improved techniques for designing and/or attaching grilles to vehicles.

One aspect of certain example embodiments of this invention relates to providing a grille attachment technique that reduces (e.g., eliminates) the need for secondary fasteners.

Another aspect of certain example embodiments relates to the use of snap-in features that are molded in the grille when attaching the grille to a vehicle.

Still another aspect of certain example embodiments relates to providing structural support to the vehicle via the grille or a portion of the grille.

A further aspect of certain example embodiments relates to an efficient (e.g., faster, less complicated, reduced cost, etc.) way of connecting a grille to a vehicle.

Yet another aspect of certain example embodiments relates to a decorative outer (outer member) connectable to an inner (or texture) capable of providing additional aesthetic features and providing additional structural support (e.g., carrying a structural load, for example, by acting as a beam). The structural inner may carry the necessary molded-in snap features to connect the assembled grille to the vehicle (e.g., via a front-end module, directly, etc.).

In certain example embodiments of this invention, a grille for a vehicle is provided. The grille may include a structural inner (inner member). The grille may also include a decorative outer (outer member) including a plurality of molded-in snap features to engage with the structural inner at a plurality of corresponding snap-receiving points or locations of the structural inner. A plurality of snap features may be molded into the structural inner and/or the decorative outer to engage with the vehicle at a plurality of corresponding attachment points or locations on the vehicle. The plurality of snap features molded into the structural inner and/or decorative outer may be arranged so as to provide a secure connection between the grille and the vehicle free from secondary fasteners therebetween.

In certain other example embodiments of this invention, a grille for a vehicle is provided. The grille may include a structural inner. The grille may also include a decorative outer including a plurality of molded-in snap features to engage with the structural inner at a plurality of corresponding snap-receiving points or locations of the structural inner. A beauty cover may be connected to the structural inner. The beauty cover may be extendable over at least a portion of the vehicle's interior and may include at least one snap feature for engaging with the vehicle. A plurality of snap features may be molded into the structural inner and/or the decorative outer to engage with the vehicle at a plurality of corresponding attachment points or locations on the vehicle. For example, a center locator may be molded into the structural inner's bottom surface at the structural inner's center. At least two grille feet may be provided, with the grille feet being formed on opposing sides of the center locator. At least two molded-in snap features may be formed on the structural inner's top surface to engage with the vehicle.

In certain example embodiments of this invention, a vehicle comprising a grille is provided. The grille may include a structural inner member. The grille may also include a decorative outer member including a plurality of molded-in snap features to engage with the structural inner member at a plurality of corresponding snap-receiving points or locations of the structural inner member. A plurality of snap features may be molded into the structural inner member and/or the decorative outer member to engage with the vehicle at a plurality of corresponding attachment points or locations on the vehicle. The plurality of snap features molded into the structural inner member and/or decorative outer member may be arranged so as to provide a secure connection between the grille and the vehicle free from secondary fasteners therebetween.

In still other example embodiments, a method of attaching a grille to a vehicle is provided. A structural inner may be injection molded so as to include at least a center locator. A decorative outer may be injection molded so as to include a plurality of molded-in snap features to engage with the structural inner at a plurality of corresponding snap-receiving points or locations of the structural inner. The structural inner and the decorative outer may be snapped together to form an assembled grille. A plurality of snap features may be molded into the structural inner and/or the decorative outer to engage with the vehicle at a plurality of corresponding attachment points or locations on the vehicle. The center locator of the structural inner may be inserted into an aperture formed in the vehicle. The structural inner may be rotated towards the vehicle with the center locator and the aperture being used as a pivot axis so that during rotation the plurality of snap features engage with the vehicle at a plurality of corresponding attachment points or locations on the vehicle forming a connection therewith. The plurality of snap features molded into the structural inner and/or the decorative outer may be arranged so as to provide a secure connection between the grille and the vehicle free from secondary fasteners therebetween.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a partial perspective view of one half of a grille and associated vehicle features according to an example embodiment;

FIG. 2 is a cross-sectional view of an illustrative construction section of a grille and associated vehicle features in accordance with an example embodiment;

FIG. 3 is a cross-sectional view of an illustrative construction section of a grille being snapped into place in accordance with an example embodiment;

FIG. 4 is an enlarged view of the upper snap portions of the cross-sectional view of FIG. 3;

FIG. 5 is an enlarged view of the lower snap portions of the cross-sectional view of FIG. 3;

FIG. 6 is a cross-sectional view of an illustrative center-line section of a grille and associated vehicle features in accordance with an example embodiment;

FIG. 7 is a cross-sectional view of an illustrative section of a grille connecting to a headlamp housing of a vehicle in accordance with an example embodiment;

FIG. 8 is a front view of an illustrative structural inner in accordance with an example embodiment;

FIG. 9 is a front view of an illustrative decorative outer in accordance with an example embodiment;

FIG. 10 is a partial perspective view of an illustrative structural inner showing beauty cover features thereof, in accordance with an example embodiment;

FIG. 11 is a rear view of an illustrative structural inner showing certain illustrative snap-in features thereof, in accordance with an example embodiment; and,

FIG. 12 is a front view of an assembled illustrative grille ready for insertion into a front-end module assembly, in accordance with an example embodiment.

### DETAILED DESCRIPTION OF EXAMPLE EMBODIMENTS OF THE INVENTION

The structural and/or secondary fastener-free grille of certain example embodiments may comprise two injection-molded components. The first piece, referred to as the “outer,” is a decorative part that typically is either chrome-plated or painted based on customer styling requirements. The second piece, referred to as the “inner” or “texture,” provides both an aesthetic function, if necessary, while also being able to carry the majority of the structural load (e.g., by acting as a beam) across the grille opening. The inner also may include the necessary molded-in features (e.g., snaps and/or spring tensioning hooks) to connect to the vehicle (e.g., via the front-end module assembly) and to locate the grille.

Thus, certain example embodiments enable a grille to be a decorative piece while also providing structure. The grille may allow an end-customer to assemble it to their front-end module or other vehicle component(s) with a reduced (e.g., eliminated) need for secondary fasteners (i.e., screws, clips, clamps and the like). This arrangement greatly reduces the overall system cost of the front end and provides a significant advantage to the end-customer through part reduction, impact performance, labor reduction, fit and finish, etc.

The assembled grille may loosely fit and snap into place. In certain example embodiments, the process of attaching such a grille to a vehicle may be automated. The structural inner and the outer may snap together using conventional techniques.

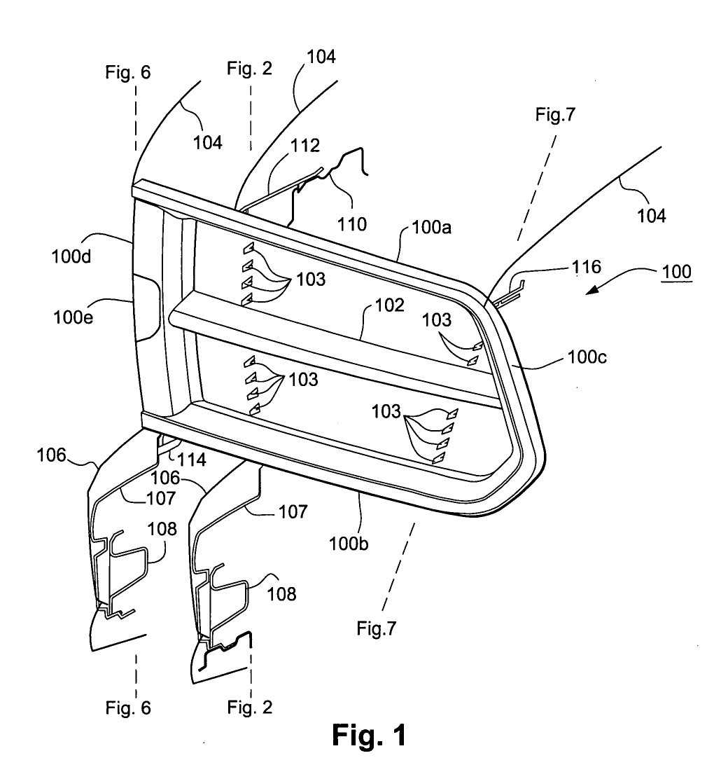

Referring now more particularly to the drawings in which like reference numerals indicate like parts throughout the several views, FIG. 1 is a partial perspective view of one half of a grille and associated vehicle features according to an example embodiment. The assembled grille 100 shown in FIG. 1 incorporates a upper portion 100a, a lower portion 100b, an outer portion 100c, and a center portion 100d. An emblem or logo may be mounted, for example, at 100e, which is approximately half-way down the center portion 100d. A center cross beam 102 also is provided, which optionally may provide structural support for the assembled grille 100. Optionally, one or more additional decorative cross beams 103 may be provided. Only a portion of the decorative cross beams 103 is shown in FIG. 1 so as to avoid obfuscating the view. In general, the decorative outer may be painted and/or plated to provide aesthetic features.

Illustrative hood contours 104 which, as shown in FIG. 1, extend to the grille, are shown. A fascia or energy absorber assembly 106 also is shown. Located within the fascia 106 of the vehicle also is an energy absorber 107 as well as the bumper beam 108, the latter of which is typically made of a metal or the like. The energy absorber 107 is connected to the main bumper beam 108. As will be described in greater detail below (e.g., with reference to FIG. 5) the grille of certain example embodiments may take advantage of the energy absorber by using it as a rest and/or attachment point for one or more of its feet.

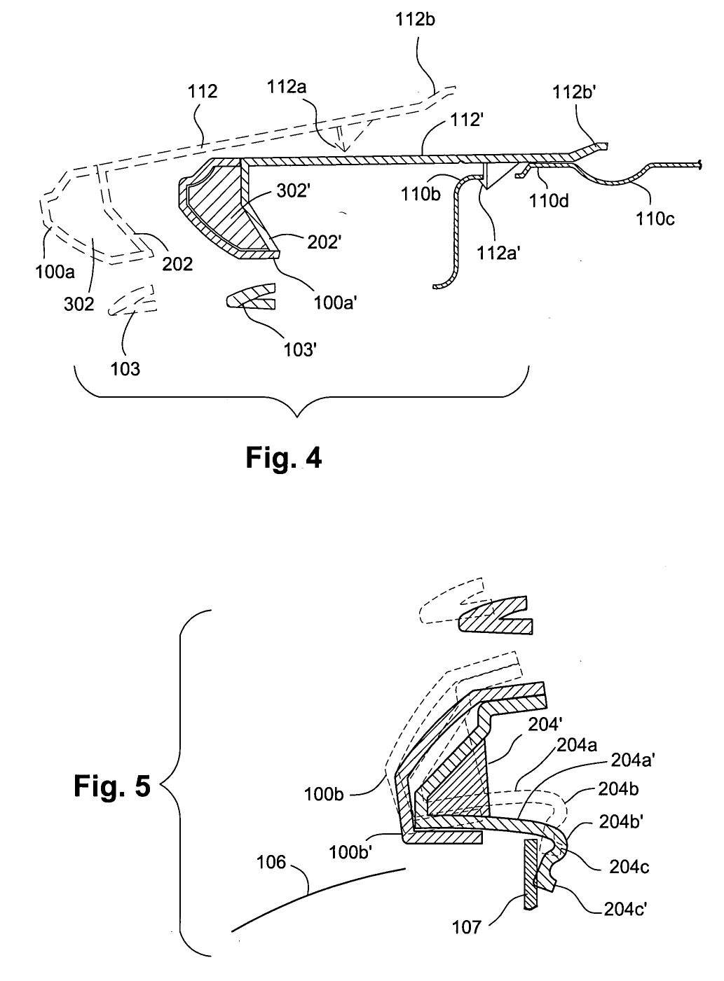

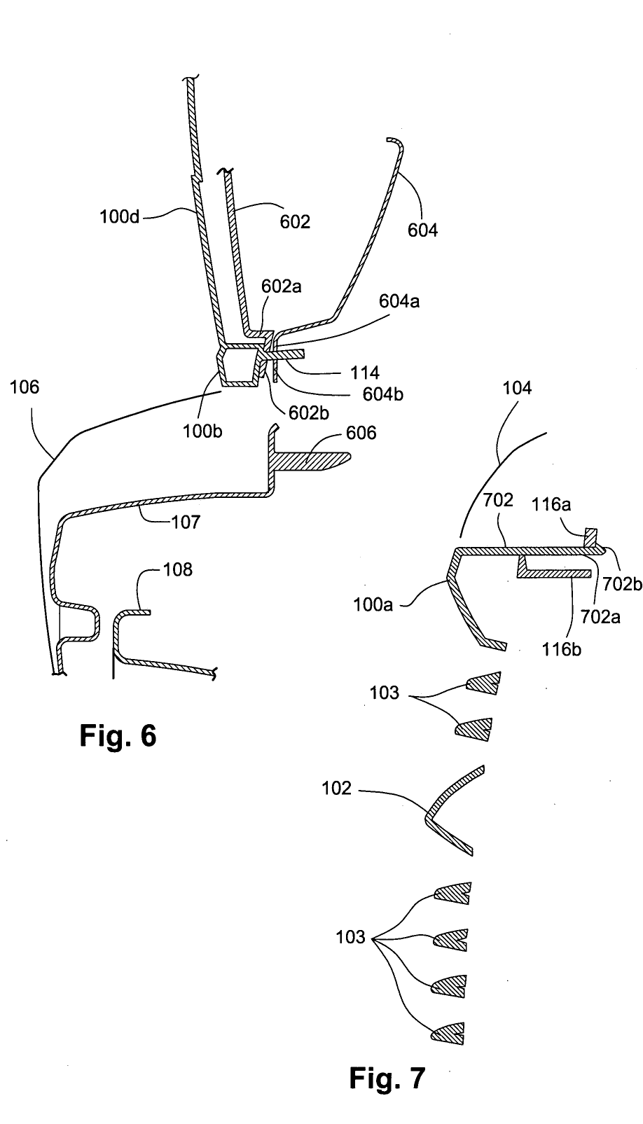

In FIG. 1, the front-end module assembly 110 is shown engaging with the beauty cover surface 112, the details of which will be provided in greater detail below (e.g., with reference to FIG. 4). In general, the front-end module assembly 110 typically holds most items (e.g., the lights, fascia, grille, etc.) to the front of the vehicle. Center locator foot 114 is shown as being located approximately in the center of the assembled grille 100 and, as will be described in greater detail below (e.g., with reference to FIG. 6), center locator foot 114 helps the assembled grille 100 and/or its components to be aligned in the proper position with respect to the vehicle and/or vehicle front-end module. Headlamp housing 116 provides an optional additional attachment location or point, and the details of this attachment will be described in greater detail below (e.g., with reference to FIG. 7).

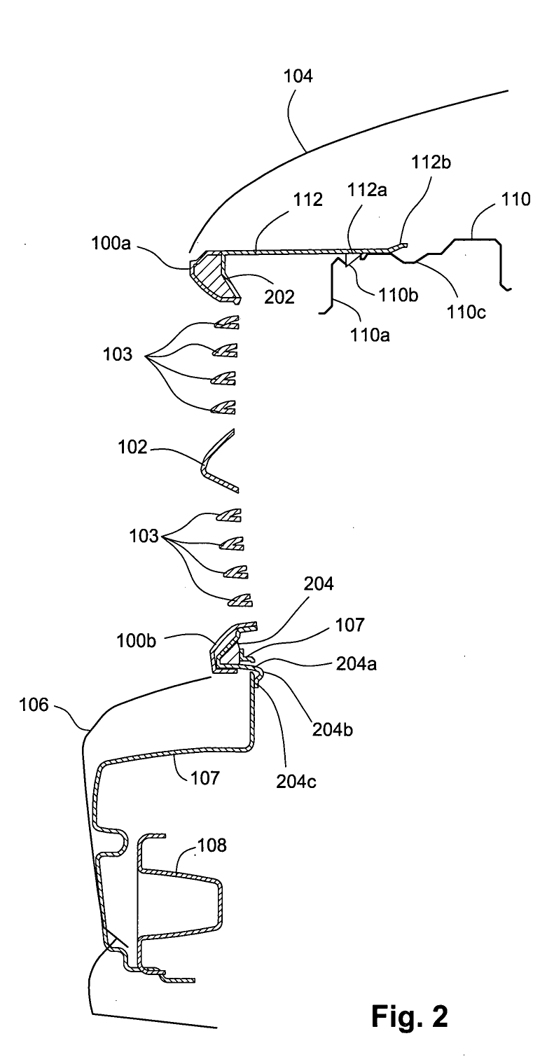

FIG. 2 is a cross-sectional view of an illustrative construction section of a grille and associated vehicle features in accordance with an example embodiment. Various illustrative components of the decorative outer are shown, including the center cross beam 102 and the decorative cross beams 103. The upper portion 100a of the decorative outer member is shown as being connected to a top part 202 of the structural inner member, and a lower portion 100b of the decorative outer member is shown as at least partially surrounding the bottom part 204 of the structural inner member along with the lower tensioning foot.

The lower tensioning foot may be molded into the grille inner member. It may comprise a hook that extends from a part of the structural inner member that is generally parallel to the ground (204a), curve (204b), and extend generally perpendicular to the ground (204c). In FIG. 2, the lower tensioning foot is shown engaging with the energy absorber 107 (e.g., a part generally parallel to the ground extends over and around the energy absorber 107 and is secured thereto by the generally perpendicular area 204c). However, in certain example embodiments, the lower tensioning foot may be connected to other parts such as, for example, the fascia, the front-end module assembly, etc.

As shown near the top of FIG. 2, a beauty cover surface 112 also may be provided. For example, the beauty cover surface 112 may be molded into the grille. The beauty cover surface 112 may extend over some or all of the width of the grille. This arrangement may conceal the radiator, headlamp assemblies, etc. In certain example embodiments, the beauty cover surface 112 may fulfill robust structural support requirements, for example, to hold a significant load when a mechanic leans on it to reach the interior portions of the vehicle. The beauty cover surface 112 also may include a snap feature 112a to engage with an engaging portion 110b of the front-end module assembly 110 proximate to a cross-member 110a of the front-end module assembly 110. A depression 110c formed in the front-end module assembly 110 may correspond to an extension 112b of the beauty cover surface 112. In certain example embodiments, a mechanic may by-hand or with a tool use the depression 110c and extension 112b portions to more conveniently, for example, remove the grille and/or beauty cover, access the radiator and/or any covered portions of the vehicle, etc.

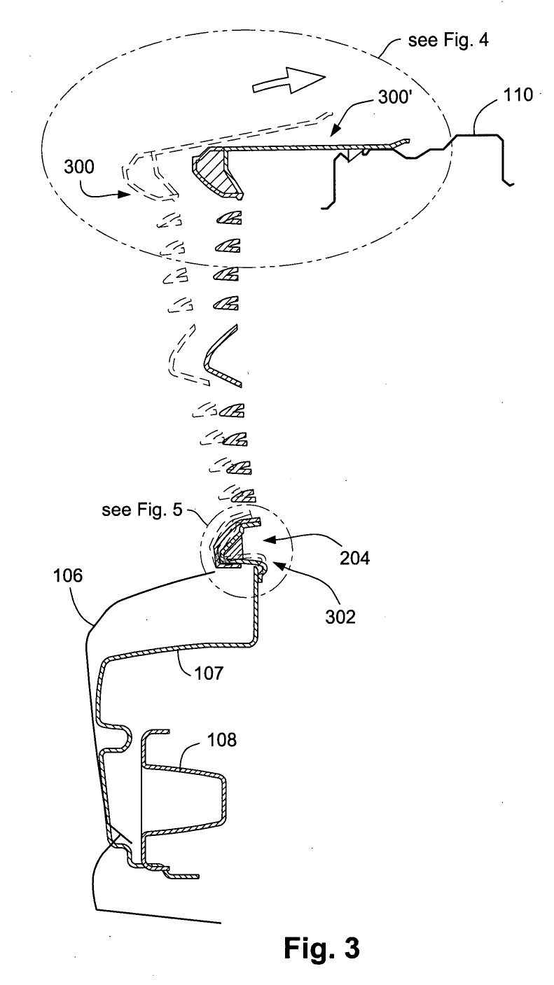

FIG. 3 is a cross-sectional view of an illustrative construction section of a grille being snapped into place in accordance with an example embodiment. As will be appreciated from FIG. 3, the fascia 106 and the components interior thereto (e.g., the energy absorber 107 and the bumper beam 108) remain in a fixed position, while the assembled grille is rocked from insertion position 300 (represented by the dashed lines) to the installed or locked position 300′ (represented by the solid lines). The grille retaining foot 302 of the structural inner (inner member) 204 is shown engaging with the energy absorber 107 so as to allow the upper portion to be rocked into place and for the appropriate snap-in features located on the upper portions of the grille to engage with their respective connections.

FIG. 4 is an enlarged view of the upper snap portions of the cross-sectional view of FIG. 3. As in FIG. 3, the dashed lines represent the insertion position and the solid lines represent the installed or locked position. As can be seen in FIG. 4, the interior portion of the structural inner 202/202′ is a structural beam 302/302′, which may be created by ribbing the inner. As noted above, a snap feature 112a/112a′ is formed on the beauty cover 112/112′, which extends into the body of the vehicle. It may be molded into the beauty cover 112/112′. The snap feature 112a/112a′ includes a barb formed on its end for engaging with the cross-member 110b. When the grille is rocked into place, the snap feature 112a pivots inward with respect to the vehicle as the barb of the snap feature 112a contacts the cross-member 110b. Once the barb has cleared the cross-member 110b, the snap feature 112a′ is in place and snaps back into its unbiased position. The cross-member 110b usually is the uppermost feature of the front-end module. Typically, the cross-member 110b bridges the area between the headlamps of a vehicle. A flat part of the front-end module assembly surface 110d is capable of supporting the beauty cover 112′ between the engagement of the snap feature 112a′ and the depression 110c.

FIG. 5 is an enlarged view of the lower snap portions of the cross-sectional view of FIG. 3. As above, the dashed lines represent the insertion position and the solid lines represent the installed or locked position. The structural inner 204′ includes a lower tensioning (or grille retaining) foot. A front-end module component, fascia 106, energy absorber 107, or other part (e.g., a mounting bracket of the fascia 106), puts tension against the structural inner 204′ to create a spring tension in the lower tensioning foot. Thus, the foot comprises a part generally parallel to the ground (204a/204a′) that hooks (204b/204b′) around the specified part (in the example embodiment shown in FIG. 5, the energy absorber 107), and includes a retaining portion that is generally perpendicular to the ground (204c/204c′). This structure rocks into position and helps hold the grille in place.

FIG. 6 is a cross-sectional view of an illustrative center-line section of a grille and associated vehicle features in accordance with an example embodiment. In FIG. 6, the energy absorber 107 is shown as having its own locator member 606. Optionally, a partial energy absorber 604 may extend upwardly behind the grille, for example, for locating and/or additional support.

The center portion 602 of the structural inner (inner member) may include a center locator foot 114 to help position the grille in the vehicle. It also may include a snap-in piece comprising a generally horizontal piece 602a connecting to a generally vertical piece 602b for engaging with the decorative outer (outer member) and/or the front-end module assembly. Optionally, when a partial energy absorber 604 is included, a substantially vertical portion 604b thereof may provide further support to the assembled grille proximate to the generally vertical portion 602b of the center portion 602 of the structural inner.

FIG. 7 is a cross-sectional view of an illustrative section of a grille connecting to a headlamp housing of a vehicle in accordance with an example embodiment. In certain vehicles, the grille will extent to the headlamps. Thus, certain example embodiments may use the headlamp housing as an optional and/or additional attachment point. A headlamp housing 116a-b typically is formed from nylon or a suitable structural plastic (although other materials may be used). Accordingly, a molded-in auxiliary snap feature 702a-b located at the ends 702 of the beauty cover may provide additional structure and/or support. Thus, as is shown in FIG. 7, an end 702 of the beauty cover includes a snap portion 702a with a barb 702b at its end. The barb may be biased away from the headlamp housing 116a as the grille is being rocked or snapped into place. Once the barb 702b is clear of the headlamp housing 116a, however, it may snap or lock in place by returning to its unbiased position.

The locator 606 of the energy absorber may help to position the energy absorber 107 and/or the fascia 106, and the center locator foot 114 of the grille may help to locate the grille with respect to an appropriate part of the vehicle. Once the center locator is generally aligned and the other feet are inserted into their respective positions, the entire grille assembly may be rocked or snapped into place, as shown, for example, in FIG. 3. In this way, it is possible to reduce or even completely eliminate the need for additional, secondary fasteners that conventionally have been required to form secure connections by being manually screwed into place. As such, it is possible to achieve operational efficiencies, reduced component costs, ease of assembly and maintenance, etc. Moreover, in certain example embodiments, the need for a separate structural piece behind the grille may be reduced or even completely eliminated by including one or more structural components in the inner and/or designing the inner to provide structure in and of itself.

Thus, a method for attaching a grille to a vehicle in accordance with an example embodiment may comprise injection molding a structural inner so as to include at least a center locator; injection molding a decorative outer so as to include a plurality of molded-in snap features to engage with the structural inner at a plurality of corresponding snap-receiving points of the structural inner; snapping together the structural inner and the decorative outer to form an assembled grille; molding into the structural inner and/or the decorative outer a plurality of snap features to engage with the vehicle at a plurality of corresponding attachment points on the vehicle; inserting the center locator of the structural inner into an aperture formed in the vehicle; rotating the structural inner towards the vehicle with the center locator and the aperture being used as a pivot axis so that during rotation the plurality of snap features engage with the vehicle at a plurality of corresponding attachment points on the vehicle forming a connection therewith; and, arranging the plurality of snap features molded into the structural inner and/or the decorative outer so as to provide a secure connection between the grille and the vehicle free from secondary fasteners therebetween.

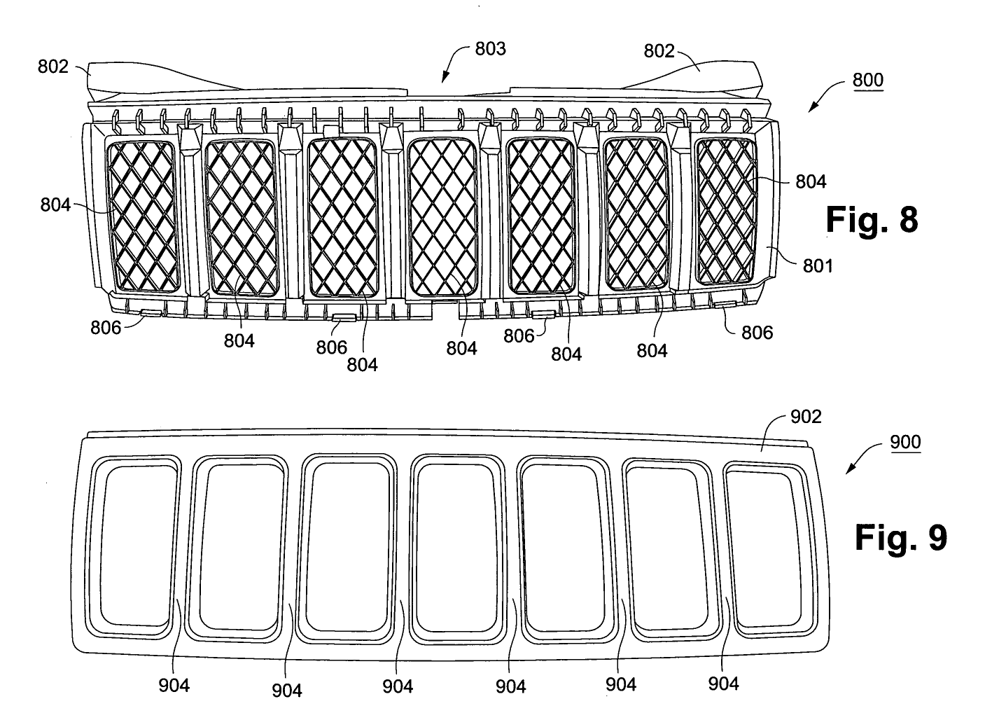

FIGS. 8-12 illustrate an example structural inner and decorative outer. It will be appreciated that the same is provided by way of example and without limitation. For example, the number, positioning, and shape of the tensioning feet, center locator, beauty cover, structural inner, decorative outer, etc. are illustrative in nature and may be varied according to the particular aesthetic, structural, and/or other needs of the particular implementation.

FIG. 8 is a front view of an illustrative structural inner 800 in accordance with an example embodiment. The structural inner comprises a main body 801 and a beauty cover 802. The beauty cover 802 includes a notched-out portion 803 to allow air flow proximate to the radiator of the vehicle and also access to the radiator. Decorative cross-pieces 804 are disposed throughout the structural inner 800. Two lower tensioning feet 806 are located on each opposing side of the center locator foot (which is not visible from the view in FIG. 8).

FIG. 9 is a front view of an illustrative decorative outer 900 in accordance with an example embodiment. The decorative outer 900 includes a main body 902. It also includes decorative vertical bars 904 to define windows through which the decorative cross-pieces 804 included as decorative features of the structural inner are visible.

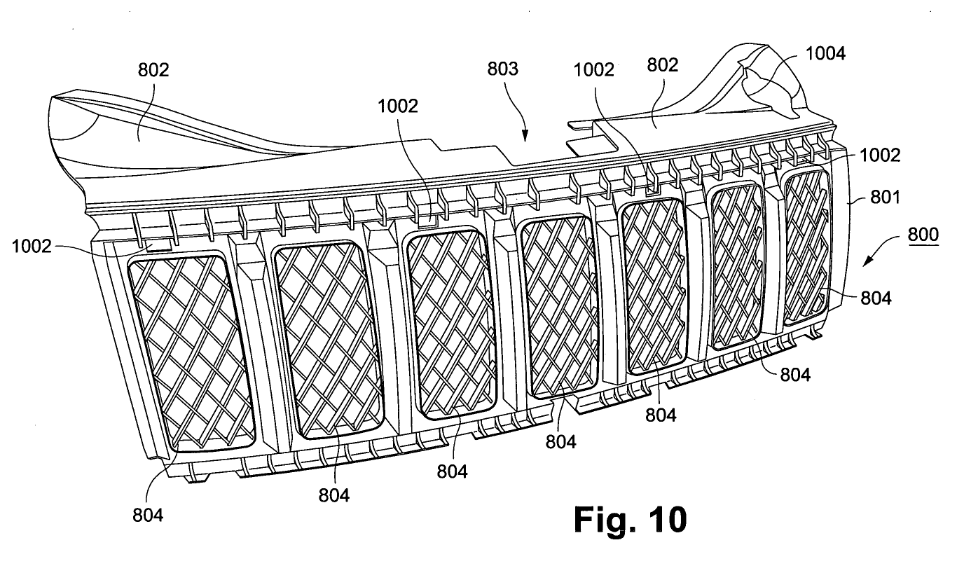

FIG. 10 is a partial perspective view of an illustrative structural inner 800 showing beauty cover 802 features thereof, in accordance with an example embodiment. As can be seen from FIG. 10, four snap-in features 1002 are provided to allow the decorative outer to connect to the structural inner. This arrangement reduces (and sometimes even eliminates) the need for additional secondary fasteners (e.g., screws) by providing a secure snap-together system at a plurality of points. Generally, the snap-in features 1002 are located on opposing sides of the center of the structural inner 800. A hole 1004 is formed in the beauty cover 802. This hole 1004 may support and/or allow access to the headlamp and/or headlamp assembly of certain example embodiments.

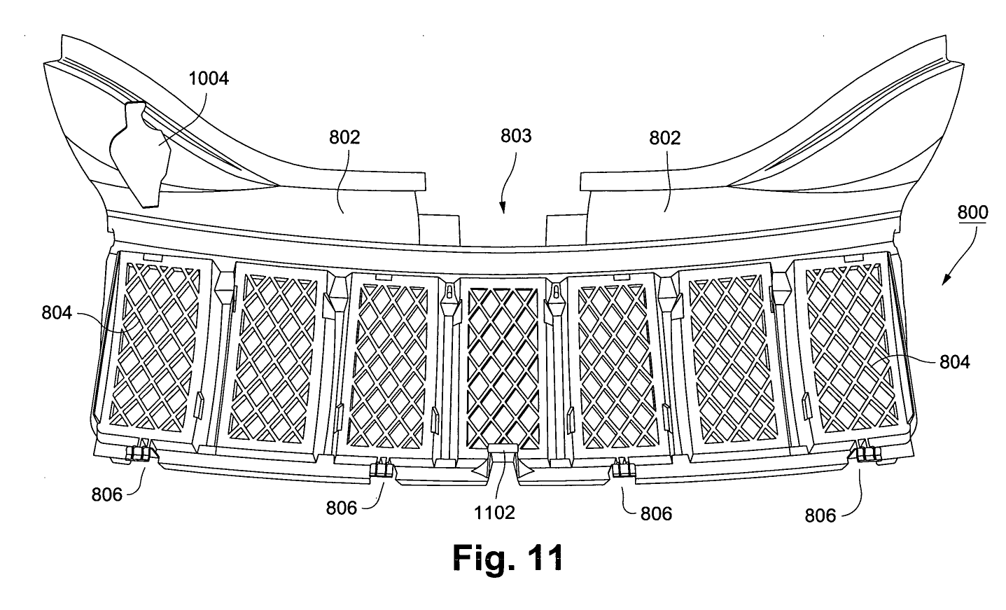

FIG. 11 is a rear view of an illustrative structural inner 800 showing certain illustrative snap-in features thereof, in accordance with an example embodiment. As can be seen from FIG. 11, the lower tensioning feet 806 protrude inwardly into the body of the vehicle. The lower tensioning feet 806 are molded-in features of the structural inner 800. A center locator foot 1102 is provided at the center of the body 801 of the structural inner 800. As can be seen from FIG. 11, the center locator foot 1102 may be large so as to facilitate the positioning of the structural inner.

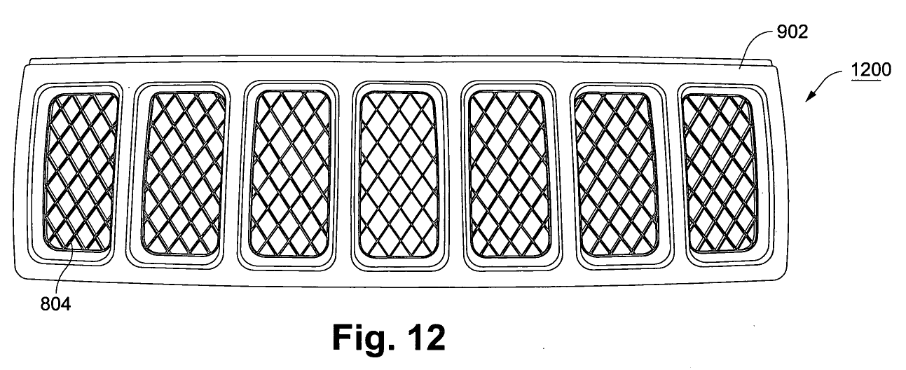

FIG. 12 is a front view of an assembled illustrative grille 1200 ready for insertion into a front-end module assembly, in accordance with an example embodiment. The decorative outer is snapped to the structural inner so that the main body 902 of the decorative outer reveals the decorative cross-pieces 804 of the structural inner through the holes formed therein.

It will be appreciated that the decorative outer may be connected to the structural inner before or after the structural inner is connected to the front-end module. It also will be appreciated that the snap-in features of certain example embodiments need not necessarily be connected to receiving portions of a front-end module. Indeed, certain example embodiments may accommodate arrangements where no front-end module is provided to the vehicle. In such cases, other attachment points may be chosen including, for example, the fascia, the energy absorber, the headlamp assemblies, etc.

It will be appreciated that the inner and/or the outer, and/or the snap features thereof may be formed via injection molding. However, certain example embodiments may provide for different materials comprising the inner and/or outer, and/or the components thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A grille for a vehicle, the grille comprising:
a structural inner member;
a decorative outer member including a plurality of molded-in snap features to engage with the structural inner member at a plurality of corresponding snap-receiving points or locations of the structural inner member;
a plurality of snap features molded into the structural inner member and/or the decorative outer member to engage with the vehicle at a plurality of corresponding attachment points or locations on the vehicle; and
wherein the plurality of snap features molded into the structural inner member and/or decorative outer member are arranged so as to provide a secure connection between the grille and the vehicle free from secondary fasteners therebetween.

2. The grille of claim 1, wherein the attachment points or locations on the vehicle include attachment points or locations on a front end module of the vehicle.

3. The grille of claim 1, wherein the attachment points or locations on the vehicle include attachment points or locations on a fascia, and/or component, of the fascia of the vehicle.

4. The grille of claim 1, wherein the attachment points or locations on the vehicle include attachment points or locations on a headlamp assembly or headlamp assemblies of the vehicle.

5. The grille of claim 1, further comprising a structural support beam in the structural inner member located across a width of the structural inner member.

6. The grille of claim 1, further comprising decorative features molded into structural inner member.

7. The grille of claim 1, further comprising a beauty cover connected to the structural inner member, the beauty cover being extendable over at least a portion of an interior of the vehicle.

8. The grille of claim 1, further comprising a center locator molded into a bottom surface of the structural inner member at a center of the structural inner member;
at least two grille feet, the grille feet being formed on opposing sides of the center locator; and,
at least two molded-in snap features formed on a top surface of the structural inner member to engage with the vehicle.

9. The grille of claim 8, further comprising at least two molded-in snap features formed on a top surface of the structural inner member configured to engage with a front-end module of the vehicle,
wherein the at least two grille feet snap into an energy absorber of the vehicle proximate to a fascia of the vehicle.

10. The grille of claim 1, further comprising a center locator molded into bottom surface of the inner member at the structural inner member's center configured to engage with an energy absorber of the vehicle proximate to a fascia of the vehicle;
four grille feet, two of said grille feet being formed on opposing sides of the center locator, each said grille foot being configured to engage with an energy absorber of the vehicle proximate to a fascia of the vehicle;
at least two molded-in snap features formed on a top surface of the structural inner member and configured to engage with a front-end module of the vehicle; and
at least two molded-in snap features formed on the structural inner member's top surface configured to engage with headlamp assembly or assemblies of the vehicle.

11. A grille for a vehicle, comprising:
a structural inner member;
a decorative outer member including a plurality of molded-in snap features to engage with the structural inner member at a plurality of corresponding snap-receiving points or locations of the structural inner member;
a beauty cover connected to the structural inner member, the beauty cover being extendable over at least a portion of an interior of the vehicle and including at least one snap feature for engaging with the vehicle; and,
a plurality of snap features molded into the structural inner member and/or the decorative outer member to engage with the vehicle at a plurality of corresponding attachment points or locations on the vehicle, comprising:
a center locator molded into a bottom surface of the structural inner member at a center of the structural inner member,
at least two grille feet, the grille feet being formed on opposing sides of the center locator; and,
at least two molded-in snap features formed on a top surface of the structural inner member to engage with the vehicle.

12. The grille of claim 11, wherein the at least one snap feature of the beauty cover is configured to connect with a cross-beam of a front-end module of the vehicle.

13. The grille of claim 11, wherein the beauty cover is formed so as to support a load placed thereon.

14. The grille of claim 11, further comprising snap features configured to connect to a headlamp assembly or headlamp assemblies of the vehicle.

15. The grille of claim 11, wherein the center locator is configured to engage with an energy absorber of the vehicle proximate to a fascia of the vehicle,
wherein each said grille foot is configured to engage with the energy absorber of the vehicle proximate to the fascia of the vehicle, and
wherein the at least two molded-in snap features formed on a top surface of the structural inner member are configured to engage with a front-end module of the vehicle.

16. The grille of claim 15, further comprising at least two molded-in snap features formed on a top surface of the structural inner member configured to engage with a headlamp assembly or headlamp assemblies of the vehicle.

17. A method of attaching a grille to a vehicle, the method comprising:
injection molding a structural inner member so as to include at least a center locator;
injection molding a decorative outer member so as to include a plurality of molded-in snap features to engage with the structural inner member at a plurality of corresponding snap-receiving points or locations of the structural inner member;
snapping together the structural inner member and the decorative outer member to form an assembled grille;
molding into the structural inner member and/or the decorative outer member a plurality of snap features to engage with the vehicle at a plurality of corresponding attachment points or locations on the vehicle;
inserting the center locator of the structural inner member into an aperture formed in the vehicle;
rotating the structural inner member towards the vehicle with the center locator and the aperture being used as a pivot axis so that during rotation the plurality of snap features engage with the vehicle at a plurality of corresponding attachment points or locations on the vehicle forming a connection therewith; and,
arranging the plurality of snap features molded into the structural inner member and/or the decorative outer member so as to provide a secure connection between the grille and the vehicle free from secondary fasteners therebetween.

18. The method of claim 17, further comprising connecting a beauty cover to the structural inner member prior to the inserting step.

19. The method of claim 17, further comprising molding into the structural inner member and/or the decorative outer member at least two grille feet on opposing sides of the center locator and at least two molded-in snap features formed on a top surface of the structural inner member,
wherein the snap features are configured to engage with the vehicle.

20. The method of claim 19, wherein the rotating is performed until the plurality of snap features engage with a front-end module of the vehicle.

21. A vehicle, comprising:
a grille, the grille comprising:
a structural inner member;
a decorative outer member including a plurality of molded-in snap features to engage with the structural inner member at a plurality of corresponding snap-receiving points or locations of the structural inner member;
a plurality of snap features molded into the structural inner member and/or the decorative outer member to engage with the vehicle at a plurality of corresponding attachment points or locations on the vehicle; and
wherein the plurality of snap features molded into the structural inner member and/or decorative outer member are arranged so as to provide a secure connection between the grille and the vehicle free from secondary fasteners therebetween.

22. The vehicle of claim 21, wherein the attachment points or locations on the vehicle include attachment points or locations on a front end module of the vehicle.

23. The vehicle of claim 21, wherein the attachment points or locations on the vehicle include attachment points or locations on a fascia, and/or component, of the fascia of the vehicle.

24. The vehicle of claim 21, wherein the attachment points or locations on the vehicle include attachment points or locations on a headlamp assembly or headlamp assemblies of the vehicle.

25. The grille of claim 21, further comprising a structural support beam in the structural inner member located across a width of the structural inner member.

26. The grille of claim 21, further comprising decorative features molded into structural inner member.

27. The grille of claim 21, further comprising a beauty cover connected to the structural inner member, the beauty cover being extendable over at least a portion of an interior of the vehicle.

28. The grille of claim 21, further comprising a center locator molded into a bottom surface of the structural inner member at a center of the structural inner member;
at least two grille feet, the grille feet being formed on opposing sides of the center locator; and,
at least two molded-in snap features formed on a top surface of the structural inner member to engage with the vehicle.

29. The grille of claim 28, further comprising at least two molded-in snap features formed on a top surface of the structural inner member configured to engage with a front-end module of the vehicle,
wherein the at least two grille feet snap into an energy absorber of the vehicle proximate to a fascia of the vehicle.

30. The grille of claim 21, further comprising a center locator molded into bottom surface of the inner member at the structural inner member's center configured to engage with an energy absorber of the vehicle proximate to a fascia of the vehicle;
four grille feet, two of said grille feet being formed on opposing sides of the center locator, each said grille foot being configured to engage with an energy absorber of the vehicle proximate to a fascia of the vehicle;
at least two molded-in snap features formed on a top surface of the structural inner member and configured to engage with a front-end module of the vehicle; and
at least two molded-in snap features formed on the structural inner member's top surface configured to engage with headlamp assembly or assemblies of the vehicle.
